(19) United States
(12) Patent Application Publication
(10) Pub. No.: US 2026/0201819 A1
(43) Pub. Date: Jul. 16, 2026

(54) TOOL FOR HANDLING AN INLET COWL OF AN AIRCRAFT TURBINE ENGINE

(71) Applicant: SAFRAN NACELLES, Gonfreville-L'Orcher (FR)

(72) Inventors: Vivien Lucienne, Moissy-Cramayel (FR); Tony Dehais, Moissy-Cramayel (FR); Francois Bellet, Moissy-Cramayel (FR)

(21) Appl. No.: 19/138,476

(22) PCT Filed: Dec. 1, 2023
(86) PCT No.: PCT/FR2023/051889

§ 371 Date: Jun. 12, 2025

(30) Foreign Application Priority Data
Dec. 16, 2022 (FR) FR2213523

(51) Int. Cl. F01D 25/28

(52) U.S. Cl. CPC F01D 25/285; F05D 2220/323; F05D 2260/02; F05D 2260/31

(57) ABSTRACT

A Tool for handling an aircraft turbine engine cowl comprises an axis, a body and a bar extending longitudinally from the body, the bar being configured to be inserted into a hole located along the axis of the cowl, the tool being configured to allow the bar to rotate relative to the body and about the longitudinal axis of the bar.

### TECHNICAL FIELD

The present invention relates to the inlet cowls of turbomachines as well as the systems for handling such inlet cowls.

In particular, the present invention relates to means for attaching and fastening a cowl to a handling system.

In general, the invention applies to any conical industrial part requiring to be hoisted with a tool, such as cowls of turbomachines or the rear plugs of nozzles.

### PRIOR ART

A turbomachine generally comprises, at the front, an inlet cowl having a general conical shape, the end of which may be rounded or not.

The main function of the cowl is to cowl front of the engine shaft of the turbomachine while guiding air flow to the driving blades of the fan of said turbomachine.

The secondary function of the cowl is to be able to withstand a bird impact as well as to ensure anti-icing thereof.

The cowl is generally heavy, in the order of 20 kg, of a conical shape with a circular base, for example with a diameter of about one metre, and with a tip that can be rounded.

The size and mass of the cowl are even more important for applications in open, uncowled engines, where the fan has a generally larger diameter than cowled engines, and where the inlet cowl is then also more massive.

The cowl generally includes connections, for example air, electrical or hydraulic connections, for example to perform its anti-icing function.

The cowl also rotates about its axis, especially at the speed of the fan blades.

All these mass and design restrictions require the use of an adapted handling tool, also known as GSE (Ground Support Equipment). In particular, the cowl should comprise an interface that facilitates its handling and/or transport with a view to its installation on a turbomachine.

For hoisting and handling, it is possible to make interfaces on the cowl in order to fasten handling tool thereto. Interfaces are usually positioned about the external diameter of the cowl. However, this is the part of the cowl with the greatest aerodynamic impact, the greatest inertia and the greatest impact on the imbalance, with the cowl ideally being as balanced as possible.

The cowl should be able to rotate, in particular during its installation in order to install it in the correct position and therefore requires, in this embodiment, to have many hoist interfaces, hence more mass which can unbalance the cowl.

### DISCLOSURE OF THE INVENTION

The purpose of the present invention is therefore to overcome the aforementioned drawbacks and to provide a handling tool minimising the number of contact points and dispensing with cowl angular position restrictions.

One object of the present invention is a tool for handling an aircraft turbomachine cowl comprising an axis, a body and a bar longitudinally extending from the body, the bar being configured to be inserted into a hole located along the axis of the cowl, the tool being configured to allow the bar to rotate relative to the body and about the longitudinal axis of said bar.

Thus, the handling tool makes it possible to carry out transport, maintenance and installation of the cowl more simply, with a single fastening point, and minimising mechanical stresses. In particular, no hoist interface is required on the external diameter of the cowl, which contributes to better aerodynamics and the absence of imbalance on said cowl. In addition, this tool makes it possible to dispense with angular gripping restrictions of a cowl, gripping being performed at a single central point through which an axis passes.

Advantageously, the tool comprises a member for spinning the bar about its longitudinal axis.

Advantageously, the tool comprises a device for spinning the bar about a second axis, the second axis being an axis orthogonal to the longitudinal axis of the bar.

In one embodiment, the tool comprises a means for braking and/or rotatably immobilising the bar inserted in the cowl.

Advantageously, the bar is threaded.

In one particular embodiment, the tool comprises a force distribution flange radially extending from a first end of the bar, the flange being configured to embrace the shape of the cowl when the second end of the bar is inserted into the hole.

Advantageously, the flange comprises screws for fastening the flange to the cowl via ports located in said cowl.

In one particular embodiment, the tool comprises hoist handles.

In one particular embodiment, the tool comprises a hoist means, for example a hoist ring, configured to be hooked up to a hoist sling.

In one particular embodiment, the tool comprises a forklift truck.

In one embodiment, the tool comprises one or more rings and at least one pedestal.

Another object of the invention is an assembly comprising a tool as defined previously and an aircraft turbomachine cowl held on the tool.

### BRIEF DESCRIPTION OF THE DRAWINGS

Other purposes, characteristics and advantages of the invention will become apparent upon reading the following description, given merely as a non-limiting example, and made with reference to the appended drawings, wherein:

FIG. 1 is a view of one embodiment of a tool for handling a cowl according to the invention;

FIG. 2 is a cross-section view of a detail of FIG. 1;

FIG. 3 is a cross-section view of an assembly comprising a cowl and a plug according to the invention;

FIG. 4 is a view of one particular embodiment of a handling tool according to the invention;

FIG. 5 is a view of an alternative of FIG. 4;

FIG. 6 is a view of an embodiment of a handling tool according to the invention adapted to transport a cowl;

FIG. 7 is a view of an embodiment of a handling tool comprising hoist handles;

FIG. 8 is a view of one embodiment of a handling tool comprising hoist handles and a spinning flywheel;

FIG. 9 is a view of one embodiment of a handling tool comprising a hoist ring and two spinning flywheels;

FIG. 10 is a view of one embodiment of a handling tool comprising a forklift;

FIG. 11 is a view of one embodiment of a cowl according to the invention;

FIG. 12 is a detailed view of an embodiment of a handling tool comprising a flange held against the cowl according to the invention; and

FIG. 13 is a cross-section view of the tool illustrated in FIG. 12.

### DETAILED DISCLOSURE OF AT LEAST ONE EMBODIMENT

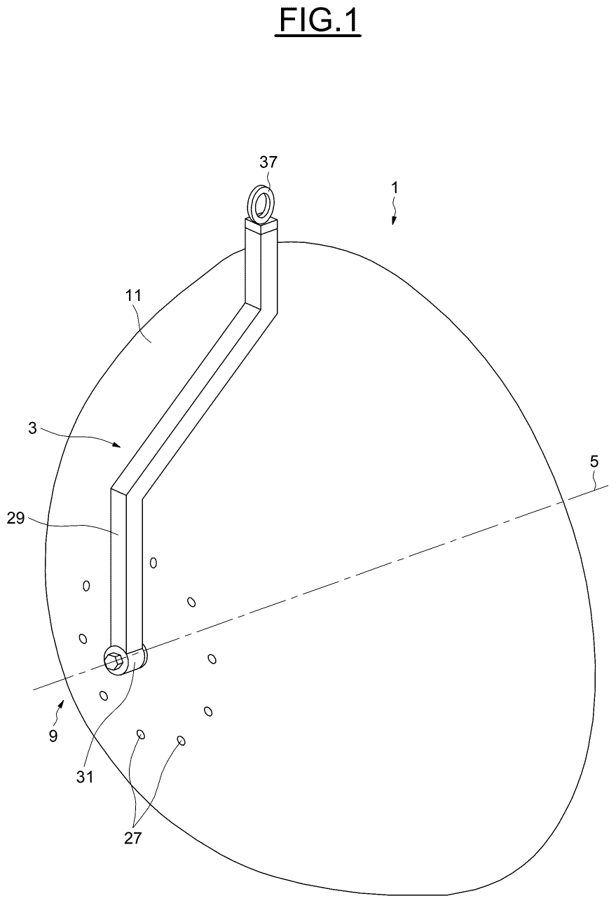

An embodiment of an industrial rotary part 1 as well as an embodiment of a handling tool 3 configured to enable the hoisting of said industrial rotary part 1 are schematically represented in FIG. 1.

An industrial part of revolution is any industrial part comprising an axis about which the industrial part has a symmetry of revolution. The industrial part is, for example, cylindrical, conical, spherical, etc.

In the embodiment illustrated, the industrial part is a cowl 1 of an aircraft engine. The aircraft engine is for example a turbomachine. The aircraft turbomachine is for example a jet engine, in particular a dual flow jet engine, or a turboprop engine.

By cowl 1, it is meant an inlet cowl, also known as a nose spinner, which corresponds to the central cone upstream of a turbomachine fan. The term cowl also refers to a central rear plug of a turbomachine nozzle.

The cowl 1 illustrated in FIG. 1 is an inlet cowl of a turbomachine comprising an axis 5. In particular, the axis 5 is coaxial with the axis of symmetry of revolution and is to be coaxial and connected with the axis of the turbomachine.

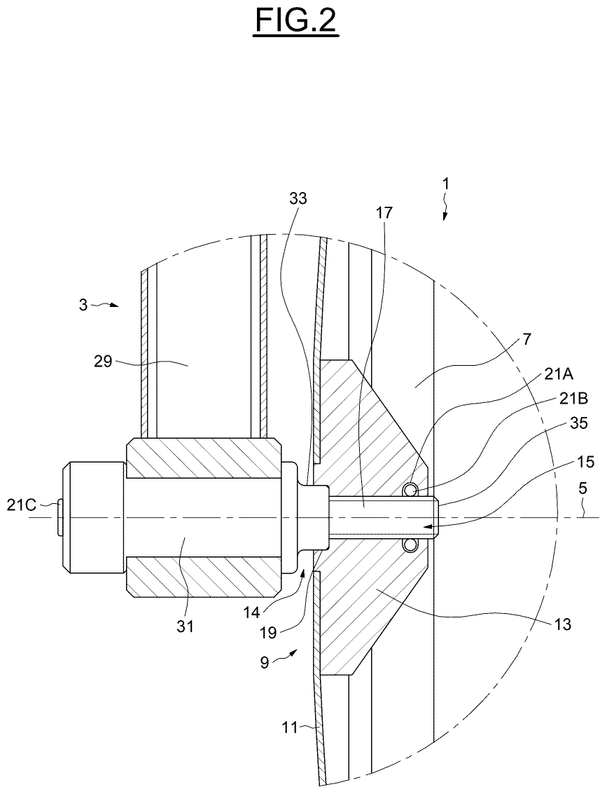

A cross-section view of a detail of FIG. 1 is represented in FIG. 2.

The cowl 1 comprises a conical truss 7 centred about the axis 5, the conical tip 9 of the truss 7 passing through the axis 5.

By conical, it is meant any shape having a circular base wider than the tip 9, wherein the tip 9 can be flattened, as illustrated in FIG. 1. Conical is defined as any shape of the ogive, cone, dome type, etc.

The conical truss 7 is made in a material resistant to the pressure conditions undergone upstream of an aircraft turbomachine.

The cowl 1 comprises an outer skin 11 fastened about the conical truss 7, so as to protect the truss 7 and form a smooth and aerodynamic coating.

The outer skin 11 comprises for example carbon and/or aluminium. The outer skin 11 has a thickness between 1 and 5 millimetres, preferably 2 millimetres.

The cowl 1 further comprises an element of revolution 13 fastened to the conical truss 7 along the axis 5 and against the outer skin 11. In particular, the element of revolution element 13 is positioned at the conical tip 9 of the cowl 1. In addition, in the presence of the element of revolution 13, the outer skin 11 is fastened to the element of revolution 13.

The element of revolution 13 especially comprises a metal material, in particular aluminium and/or a composite material. The material used for the element of revolution 13 is robust and allows gripping and hoisting of the cowl 1 via said element of revolution 13. For this purpose, the thickness of the element of revolution 13 is between 3 and 25 centimetres. The shape of the element of revolution 13 can be modified, the latter being able to serve as a stockpile for balancing the cowl 1.

The element of revolution 13, due to a positioning at the tip 9 of the cowl 1, furthermore makes it possible to represent a good reference for other applications, for example for manufacturing the cowl 1.

The cowl 1 further comprises a hole coaxial to the axis 5 and extending through the outer skin 11 as well as into the element of revolution 13. More precisely, the outer skin 11 and the element of revolution 13 each comprise a hole 14 and a hole 15 respectively. These holes 14 and 15 are aligned with each other and coaxial with the axis 5. Thus, the handling tool 3, which comprises a bar 17, in particular a bar 17 with a diameter that is less than or equal to that of the holes 14 and 15, allows gripping and hoisting of the cowl 1 by inserting said bar 17 into the holes 14 and 15. The bar 17 is optionally threaded.

The element of revolution 13 thus creates a handling interface. Its positioning in the centre of the cowl 1 allows better balancing without imbalance and without the need for a plurality of sling rings on the periphery of the cowl 1. Handling is easier and the aerodynamic performance of the cowl 1 is improved.

In one particular embodiment, the hole 15 passes completely through the element of revolution 13. Thus, a bar 17 inserted into the hole 15 can protrude from the other side of the element of revolution 13 in order, for example, to fasten it and prevent it from disengaging.

The through holes 14 and 15 also make it possible to carry out endoscopic checks, or to be able to introduce cables or tubes into the cowl 1 through the holes 14 and 15, for example to carry out installation or maintenance of a device such as an anti-icing device.

The holes 14 and 15 allow, in addition to insertion of a handling tool 3, insertion of a holding tool for transporting the cowl.

In one particular embodiment, the element of revolution 13 comprises an annular shoulder 19. More specifically, the hole 15 has a wider diameter at the tip 9 of the cowl 1, the diameter of the hole 15 narrowing in the element of revolution 13 so as to form said annular shoulder 19. The shoulder 19 allows improving spinning force transfer.

The hole 15 may optionally comprise a simple bore, i.e. comprise a smooth, in other words non-threaded, inner surface.

Alternatively, the hole 15 comprises a means for longitudinally locking the bar 17 along the axis 5. For example, the locking means comprises a thread on the inner surface of the hole 15. In other words, the element of revolution 13 comprises a thread pointing to the hole 15.

The thread can thus allow a better fastening of a bar 17 threaded in the hole 15, although a handling tool 3 with a non-threaded bar 17 can still be employed.

Optionally, the hole 15 comprises a means 21A configured to brake and/or immobilise the bar 17 inserted into the hole 15. In other words, the element of revolution comprises the means 21A at the hole 15. This means 21A makes it possible to ensure holding of the bar 17 in the cowl 1 during handling in order to avoid any accident at the handling place. The means is for example a cavity 21A configured to accommodate and lock one or more balls 21B of a ball-lock included in the bar 17 and the radial movement of the balls of which is activatable by a button 21C positioned outside the hole 15 so as to be accessible by an operator.

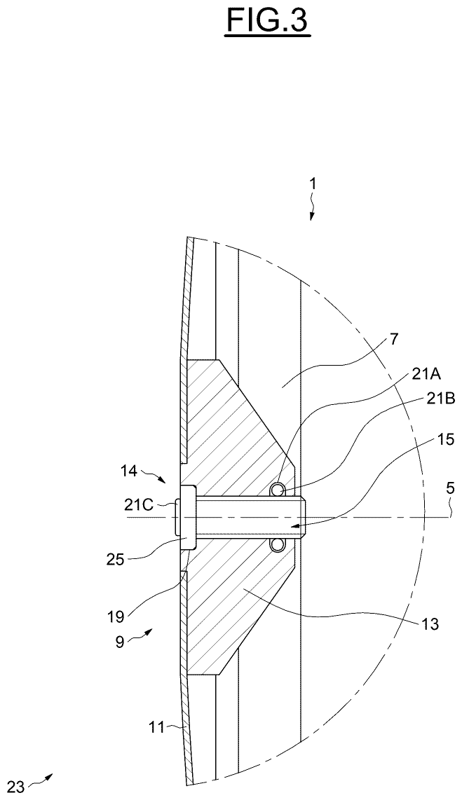

A cross-section view of a detail of one embodiment of an assembly 23 according to the invention is represented in FIG. 3. The assembly comprises a cowl 1 as illustrated in FIGS. 1 and 2, as well as a plug 25 configured to plug the hole 15 when the cowl 1 is fastened to an aircraft turbomachine.

Indeed, the presence of the hole 15 in the cowl 1 may be detrimental to the aerodynamics of the aircraft once the cowl 1 is installed on a turbomachine of said aircraft. In addition, during flight, compressed air at over 600 km/h would enter the cowl 1, while on the ground, animals could nest in the cowl 1. Thus, installing a plug 25 at the end of the hole 15 is advantageous. In particular, the plug 25 can be threaded, just like the hole 15, so as to be screwed into the hole 15. For example, the plug 25 bears on the shoulder 19, if applicable.

In one particular embodiment, the sense of threading of the hole 15 is reversed with respect to the sense of rotation for which the cowl 1 is designed, stated differently with respect to the sense of rotation of the fan when the cowl 1 is a fan nose. For example, if the turbomachine in operation intended for which the cowl 1 rotates in a first sense, the thread of the hole 15 should be oriented in the opposite sense. This embodiment makes it possible to prevent the hole 15 from unplugging itself during flight of the aircraft. Advantageously, the plug 25 is thus further tightened autonomously during flight.

In the embodiment in which the hole 15 comprises a means 21A configured to brake and/or immobilise the bar 17 in the hole 15, said means 21A can also make it possible to immobilise the plug 25 when the latter is in place.

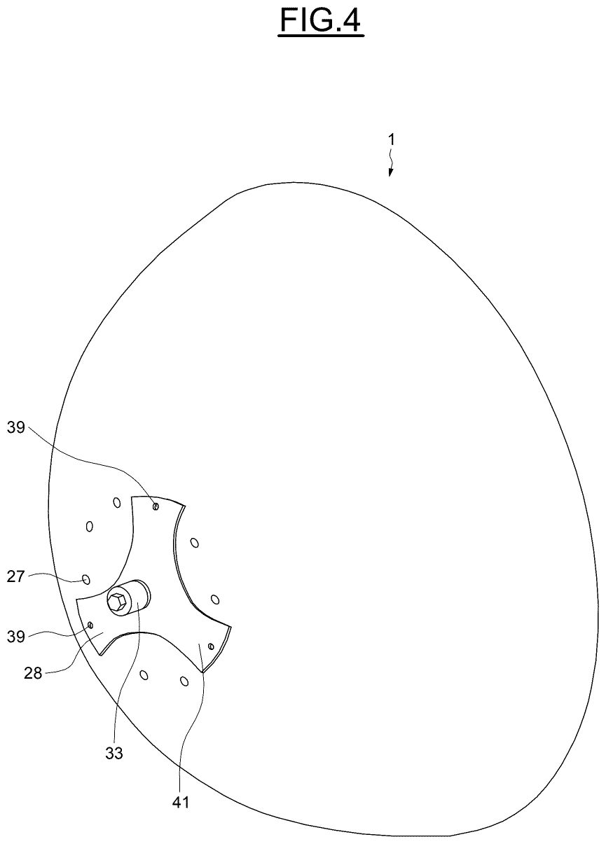

Optionally, the cowl 1 comprises a plurality of ports 27 made about the hole 15, the ports 27 extending through the outer skin 11 and into the element of revolution 13, for example in the form of threaded bushings normal to the surface of the cowl 1. The holes 27 allow insertion of screws in order to fasten a flange 28 of the handling tool 3 to the cowl 1 as illustrated in FIG. 4. The assembly 23 of the cowl 1 and the plug 25 also comprises a plurality of seals (not represented) for plugging the plurality of ports 27 and prevent air from entering the cowl 1.

The cowl 1 is generally configured to be used with the handling tool 3 described below.

In the embodiment illustrated in FIG. 1, the handling tool 3 comprises a body 29 and a bar 17 such as the bar 17 previously set forth. The bar 17 extends along its longitudinal axis from the body 29 distally. The bar 17 is thus configured to be inserted into a hole of a cowl such as the hole 15 described previously. For example, the body 29 is connected to the bar 17 via a pivot connection 31 as illustrated in FIG. 2. The bar 17 comprises a first end 33 in contact with the pivot connection 31 as well as a second end 35 to be inserted into the hole 15. The bar 17 is optionally threaded.

The tool 3 is configured to allow rotation of the bar 17 relative to the body 29 and about the longitudinal axis of said bar 17, the longitudinal axis of the bar 17 being to be coaxial with the axis 5.

Optionally, the tool 3 comprises a means 21B configured to brake and/or rotatably immobilise the bar 17 inserted into the hole 15. This means 21B makes it possible to ensure holding of the bar 17 in the cowl 1 during handling in order to avoid any accident at the handling place. The means is for example one or more balls 21B of a ball-lock included in the bar 17 and the radial movement of the balls of which can be activated by a button 21C positioned outside the hole 15 so as to be accessible by an operator. The balls 21B are configured to be accommodated and locked in a cavity 21A of the hole 15.

Thus, when the bar 17 is inserted into the hole 15, the bar 17 comprising a shoulder bearing on the shoulder 19, if applicable, it can make it possible to lift the cowl 1 and in particular make it possible to rotate the cowl 1.

In the embodiment illustrated in FIG. 1, the tool 3 comprises a hoist means 37 such as a hoist ring 37 configured to be hooked up to a hoist sling and positioned vertically to the centre of gravity of the assembly comprising the tool 3 and the cowl 1.

The tool 3 thus makes it possible to hoist the cowl 1, for example so as to install it on an aircraft turbomachine, and simultaneously make the necessary connections and screw fastenings.

One particular embodiment of a handling tool 3 as well as a cowl 1 as illustrated in FIG. 1 are represented in FIG. 4.

In FIG. 4, the body 29 of the handling tool 3 is not represented.

The tool 3 comprises a force distribution flange 28 radially extending from the first end 33 of the bar 17 and having a conical shape, more precisely complementary to the shape of the cowl 1, in particular complementary to the tip 9 of the cone formed by the cowl 1. The flange 28 thus makes it possible to distribute hoisting and rotation forces elsewhere than at the bar 17 and the hole 15 by contact between the flange 28 and the cowl 1.

Optionally, the flange 28 comprises screws 39 for fastening the flange 28 to the cowl 1. The fastening screws 39 are inserted, for example, into the ports 27 of the cowl 1. The flange 28 comprises for example three lobes 41, each lobe 41 comprising at least one screw 39 for fastening the flange 28 to the cowl 1.

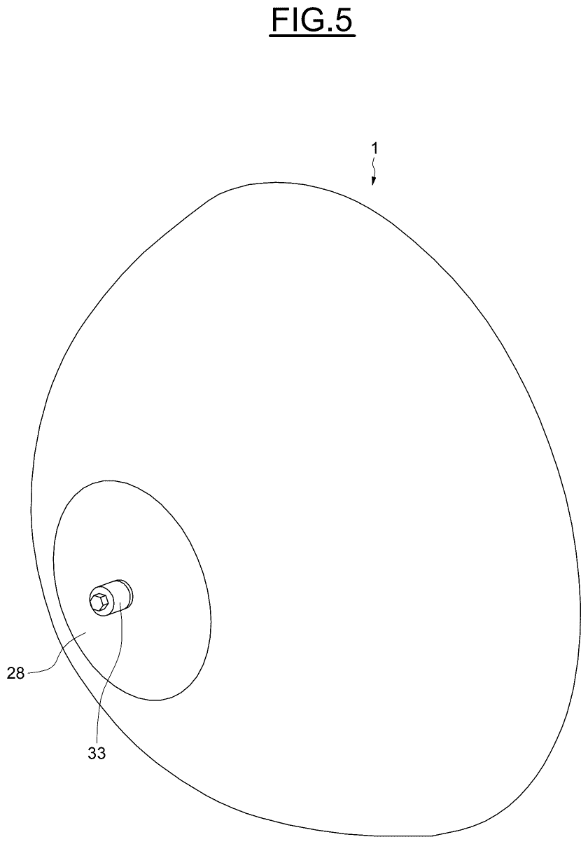

An alternative to FIG. 4, in which the flange 28 does not comprise a fastening screw 39, only the contact of the flange 28 with the cowl 1 allowing force distribution, is represented in FIG. 5.

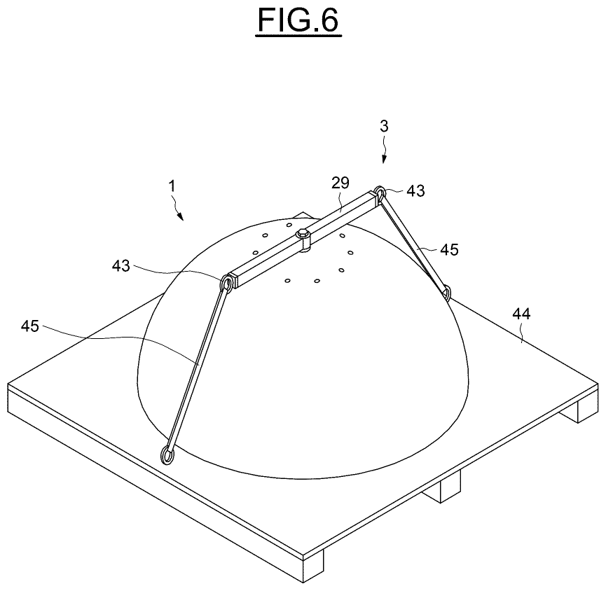

One particular embodiment of a handling tool 3, as well as a cowl 1 according to FIG. 1 have been represented in FIG. 6.

In this embodiment, the handling tool 3 comprises several rings 43, for example hoist rings, for fastening the cowl 1 to a pedestal 44 and to transport it easily, for example using straps 45.

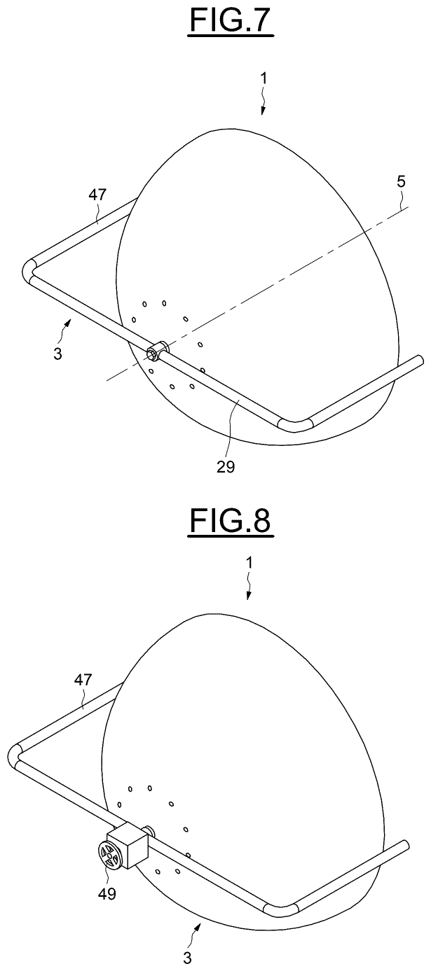

One particular embodiment of the handling tool 3 as well as a cowl 1 similar to that of FIG. 1 have been represented in FIG. 7.

The handling tool 3 comprises hoist handles 47 which can be gripped by one or more operators.

In this embodiment, two operators can support the cowl 1 while a third performs installation or maintenance operations. The cowl 1 can be spun about its axis 5, for example by turning it by hand.

One alternative of the embodiment of FIG. 7 has been represented in FIG. 8.

In this alternative, the tool 3 comprises a member 49 for spinning the bar 17 about its longitudinal axis. The member 49 thus facilitates a more accurate spinning. The member 49 is for example a flywheel.

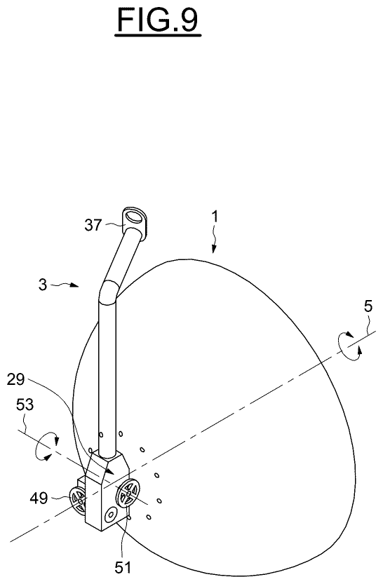

Another embodiment of a handling tool 3 as well as a cowl 1 are shown in FIG. 9.

In this embodiment, the tool 3 comprises a hoist ring 37 positioned vertically to the centre of gravity of the assembly comprising the tool 3 and the cowl 1, a member 49 for spinning the bar 17 about its longitudinal axis, to be coaxial with the axis 5, as well as a device 51 for spinning the bar 17 about a second axis 53 orthogonal to the longitudinal axis of the bar 17. The second axis 53 is in particular horizontal when the cowl 1 is in position to be installed on the turbomachine.

The device 51 is for example a flywheel. In particular, it makes it possible to move the cowl 1 from a transport position as illustrated in FIG. 6 to an installation position as illustrated in FIG. 9.

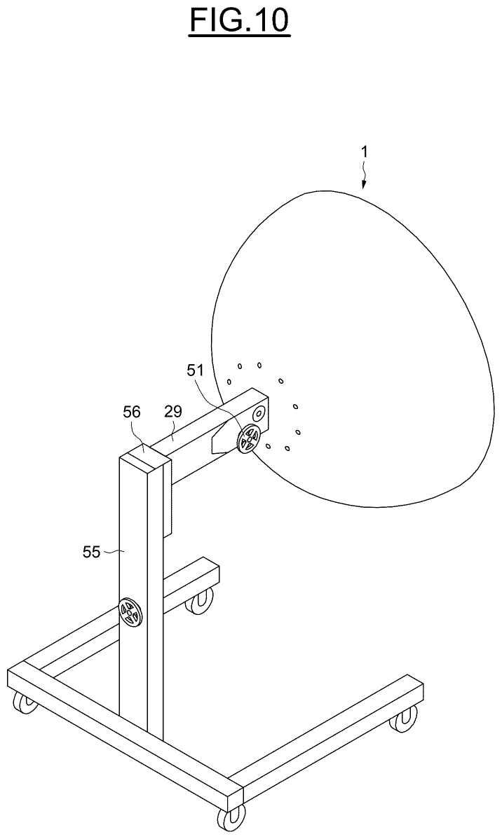

Another embodiment of the handling tool 3 is represented in FIG. 10.

In this embodiment, the handling tool 3 comprises a forklift 55 connected to the body 29 for supporting the body 29. The forklift 55 comprises a means 56 for adjusting height of the body, for example by means of a crank or a flywheel, with a view to installing or maintaining the cowl 1 on the turbomachine for example. For example, the forklift 55 comprises castors allowing it to be movable.

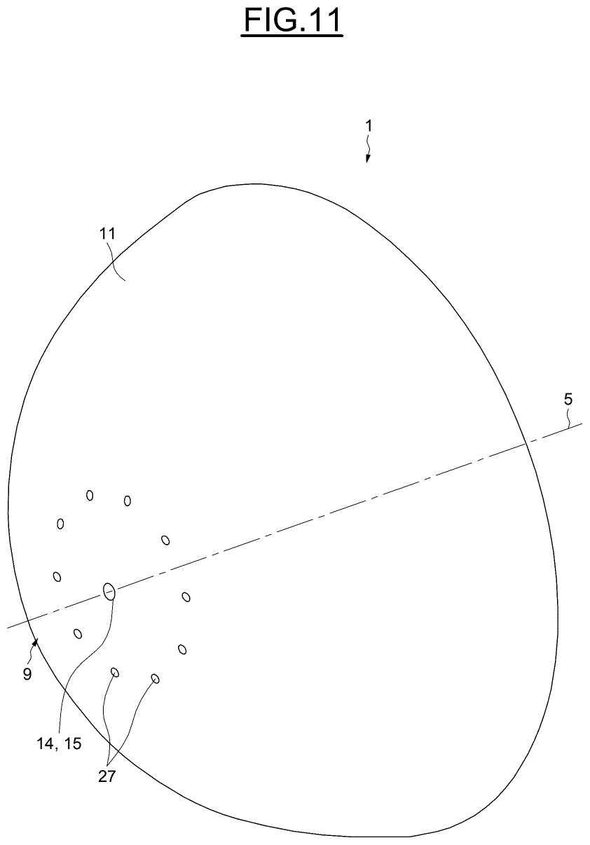

For the sake of clarity, only a cowl 1 is represented in FIG. 11. In the embodiment represented, the holes 14 and 15 formed respectively in the outer skin 11 and the element of revolution 13 are illustrated. In addition, the cowl 1 comprises a plurality of ports for fastening a flange 28.

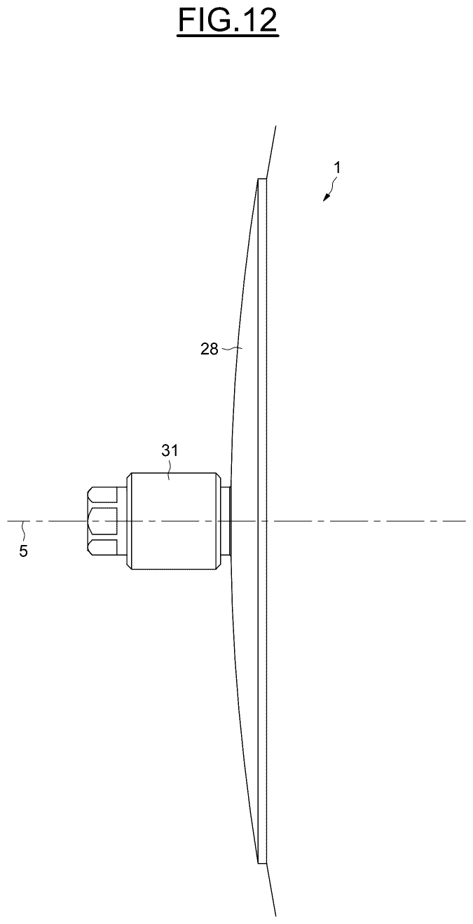

A detailed view of a handling tool 3 is also represented in FIG. 12. The detail illustrates the pivot link 31 as well as the flange 28 held on the cowl 1.

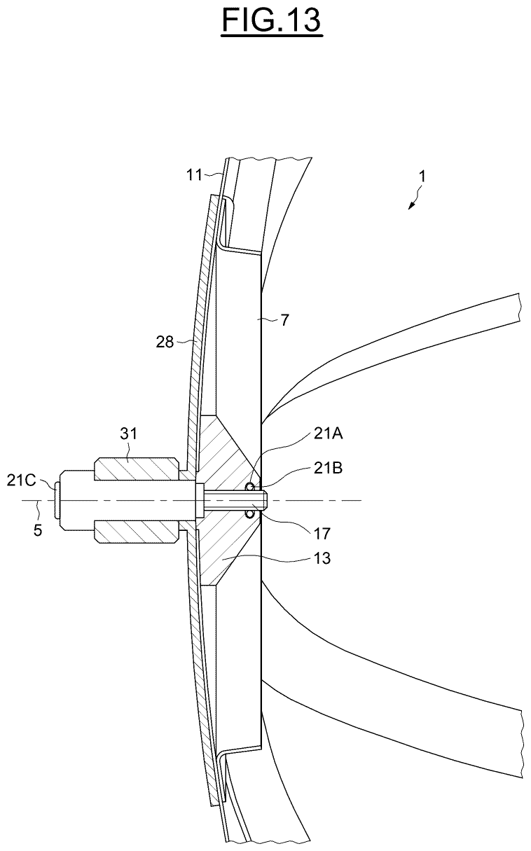

FIG. 13 is a cross-cross-section view of the embodiment illustrated in FIG. 12 and illustrates a pivot connection 31 at the end of which the bar 17 is positioned, for example made as one piece with the flange 28.

All embodiments described above are compatible with each other. In particular, the tool 3 may comprise both hoist handles 47, a hoist ring 37 as well as a forklift 55, as well as either of the member and device 49 and 51.

1. A tool for handling an aircraft turbomachine cowl, comprising an axis, a body and a bar longitudinally extending from the body, the bar being configured to be inserted into a hole located along the axis of the cowl, the tool being configured to allow the bar to rotate relative to the body and about the longitudinal axis of said bar.

2. The tool according to claim 1, comprising a member for spinning the bar about its longitudinal axis.

3. The tool according to claim 1, comprising a device for spinning the bar about a second axis, the second axis being an axis orthogonal to the longitudinal axis of the bar.

4. The tool according to claim 1, wherein the bar is threaded.

5. The tool according to claim 1, comprising a force distribution flange radially extending from a first end of the bar, the flange being configured to embrace the shape of the cowl when the second end of the bar is inserted into the hole.

6. The tool according to claim 5, wherein the flange comprises screws for fastening the flange to the cowl via ports located in said cowl.

7. The tool according to claim 1, comprising hoist handles.

8. The tool according to claim 1, comprising a hoist means, for example a hoist ring, configured to be hooked up to a hoist sling.

9. The tool according to claim 1, comprising one or more rings and at least one strap configured to attach the cowl to a pedestal.

10. An assembly comprising a tool according to claim 1 and an aircraft turbomachine cowl held on the tool.
